(19) United States
(12) Patent Application Publication
(10) Pub. No.: US 2022/0148313 A1
(43) Pub. Date: May 12, 2022

(54) METHOD FOR PROCESSING AUDIO AND VIDEO INFORMATION, ELECTRONIC DEVICE AND STORAGE MEDIUM

(71) Applicant: SHENZHEN SENSETIME TECHNOLOGY CO., LTD., Shenzhen (CN)

(72) Inventors: Xuefeng HUANG, Shenzhen (CN); Liwei WU, Shenzhen (CN); Rui ZHANG, Shenzhen (CN)

(73) Assignee: SHENZHEN SENSETIME TECHNOLOGY CO., LTD., Shenzhen (CN)

(21) Appl. No.: 17/649,168

(22) Filed: Jan. 27, 2022

Related U.S. Application Data
(63) Continuation of application No. PCT/CN2019/121000, filed on Nov. 26, 2019.

(30) Foreign Application Priority Data
Sep. 27, 2019 (CN) 201910927318.7

(51) Int. Cl. G06V 20/40; G06V 10/80; G10L 25/51; G06V 40/16

(52) U.S. Cl. CPC G06V 20/46; G06V 40/172; G10L 25/51; G06V 10/806

(57) ABSTRACT

A method for processing audio and video information includes: audio information and video information of an audio and video file are acquired; feature fusion is performed on a spectrum feature of the audio information and a video feature of the video information based on time information of the audio information and time information of the video information to obtain at least one fused feature; it is determined, based on the at least one fused feature, whether the audio information and the video information are synchronous.

### CROSS-REFERENCE TO RELATED APPLICATIONS

This is a continuation of International Application No. PCT/CN 2019/121000 filed on Nov. 26, 2019, which claims priority to Chinese Patent Application No. 201910927318.7 filed on Sep. 27, 2019. The disclosures of these applications are hereby incorporated by reference in their entirety.

### BACKGROUND

For many audio and video files, the audio and video files can be formed by a combination of audio information and video information. In some liveness detection scenarios, an identity of a user can be verified through an audio and video file recorded by the user as instructed, for example, an audio and video file that the user reads a specified array sequence is used for verification. A common attack means is to forge an audio and video file to attack.

### SUMMARY

The disclosure relates to the field of electronic technologies and discloses a method and device for processing audio and video information, an electronic device and a storage medium.

According to a first aspect of the disclosure, a method for processing audio and video information is provided, which may include the following operations.

Audio information and video information of an audio and video file are acquired. Feature fusion is performed on a spectrum feature of the audio information and a video feature of the video information based on time information of the audio information and time information of the video information to obtain at least one fused feature. It is determined, based on the at least one fused feature, whether the audio information and the video information are synchronous.

According to a second aspect of the disclosure, a device for processing audio and video information is provided, which may include an acquisition module, a fusion module and a judgment module.

The acquisition module may be configured to acquire audio information and video information of an audio and video file.

The fusion module may be configured to perform feature fusion on a spectrum feature of the audio information and a video feature of the video information based on time information of the audio information and time information of the video information to obtain at least one fused feature.

The judgment module may be configured to determine, based on the at least one fused feature, whether the audio information and the video information are synchronous.

According to a third aspect of the disclosure, an electronic device is provided, which may include: a processor; and a memory configured to store an instruction executable by the processor. The processor may be configured to: acquire audio information and video information of an audio and video file; perform feature fusion on a spectrum feature of the audio information and a video feature of the video information based on time information of the audio information and time information of the video information to obtain at least one fused feature; and determine, based on the at least one fused feature, whether the audio information and the video information are synchronous.

According to a fourth aspect of the disclosure, a non-transitory computer-readable storage medium is provided. The computer-readable storage medium has stored thereon a computer program instruction that, when executed by a processor, causes the processor to: acquire audio information and video information of an audio and video file; perform feature fusion on a spectrum feature of the audio information and a video feature of the video information based on time information of the audio information and time information of the video information to obtain at least one fused feature; and determine, based on the at least one fused feature, whether the audio information and the video information are synchronous.

According to a fifth aspect of the disclosure, a computer program is provided, which may include a computer-readable code that, when being run in an electronic device, enable a processor in the electronic device to execute the method for processing audio and video information in the first aspect.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of a method for processing audio and video information according to an embodiment of the disclosure.

FIG. 2 is a flowchart of a process for obtaining a spectrum feature of audio information according to an embodiment of the disclosure.

FIG. 3 is a flowchart of a process for obtaining a video feature of video information according to an embodiment of the disclosure.

FIG. 4 is a flowchart of a process for obtaining fused feature(s) according to an embodiment of the disclosure.

FIG. 5 is a block diagram of an example of a neural network according to an embodiment of the disclosure.

FIG. 6 is a block diagram of another example of a neural network according to an embodiment of the disclosure.

FIG. 7 is a block diagram of yet another example of a neural network according to an embodiment of the disclosure.

FIG. 8 is a block diagram of a device for processing audio and video information according to an embodiment of the disclosure.

FIG. 9 is a block diagram of an example of an electronic device according to an embodiment of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is illustrated in the drawings, the drawings are not required to be drawn to scale, unless otherwise specified.

Herein, the special term “exemplary” refers to “use as an example, embodiment or description”. Herein, any “exemplarily” described embodiment may not be explained to be superior to or better than other embodiments.

In the disclosure, the term “and/or” is only an association relationship describing associated objects and represents that three relationships may exist. For example, A and/or B may represent three conditions: i.e., independent existence of A, existence of both A and B and independent existence of B. In addition, the term “at least one” in the disclosure represents any one of multiple or any combination of at least two of multiple. For example, including at least one of A, B or C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

According to an audio and video information processing solution provided in the embodiments of the disclosure, audio information and video information of an audio and video file may be acquired, and feature fusion is performed on a spectrum feature of the audio information and a video feature of the video information based on time information of the audio information and time information of the video information to obtain at least one fused feature, so that it may be ensured that the spectrum feature and the video feature are aligned in time during fusion to obtain accurate fused feature(s). It is determined, based on the at least one fused feature, whether the audio information and the video information are synchronous, so that the accuracy of a judgment result is improved.

In a related solution, timestamps may be set for the audio information and the video information respectively in a generation process of the audio and video file, so that a receiving end may judge, through the timestamps, whether the audio information and the video information are synchronous or not. This solution requires a right of controlling a generating end of the audio and video file. However, in many cases, the right of controlling the generating end of the audio and video file cannot be ensured, and consequently, this solution is restricted in an application process. In another related solution, the audio information and the video information may be detected respectively, and then a matching degree of the time information of the video information and the time information of the audio information is calculated. In this solution, the judgment process is relatively complicated, and the accuracy is relatively low. In the audio and video information processing solution provided in the embodiments of the disclosure, the judgment process is relatively simple, and the judgment result is relatively accurate.

The audio and video information processing solution provided in the embodiments of the disclosure may be applied to any scenario of judging whether audio information and video information in audio and video information are synchronous or not, for example, correcting an audio and video file, or for another example, determining an offset of audio information and video information of an audio and video file. In some implementation modes, the solution may also be applied to a task of judging a living body by use of audio and video information. It is to be noted that the audio and video information processing solution provided in the embodiments of the disclosure is not limited by an application scenario.

The audio and video information processing solution provided in the embodiments of the disclosure will be described below.

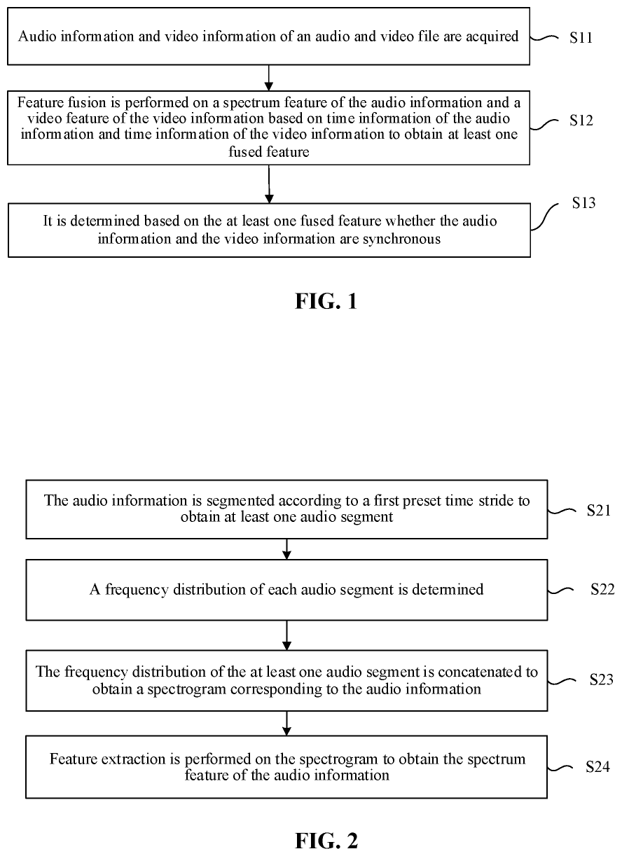

FIG. 1 is a flowchart of a method for processing audio and video information according to an embodiment of the disclosure. The method for processing audio and video information may be performed by a terminal device, or an electronic device of another type. The terminal device may be User Equipment (UE), a mobile device, a user terminal, a terminal, a cell phone, a cordless phone, a Personal Digital Assistant (PDA), a handheld device, a computing device, a vehicle device, a wearable device, or the like. In some possible implementation modes, the method for processing audio and video information may be implemented by a processor through calling a computer-readable instruction stored in a memory. The method for processing audio and video information of the embodiment of the disclosure will be described below with the condition that a performing entity is an electronic device as an example.

As illustrated in FIG. 1, the method for processing audio and video information may include the following operations.

In operation S11, audio information and video information of an audio and video file are acquired.

In the embodiment of the disclosure, the electronic device may receive an audio and video file sent by another device or may acquire a locally stored audio and video file, and then may extract the audio information and video information in the audio and video file. Herein, the audio information of the audio and video file may be represented by a magnitude of a collected level signal, namely may be a signal of which a sound intensity is represented by a time-varying high or low level value. A high level and a low level are relative to a reference level. For example, if the reference level is 0 volt, a level higher than 0 volt may be considered as a high level, and a level lower than 0 volt may be considered as a low level. If the level value of the audio information is a high level, it may be indicated that the sound intensity is greater than or equal to a reference sound intensity. If the level value of the audio information is a low level, it may be indicated that the sound intensity is less than the reference sound intensity. The reference sound intensity corresponds to the reference level. In some implementation modes, the audio information may also be an analogue signal, namely may be a signal of which the sound intensity changes continuously with time. Herein, the video information may be a video frame sequence and may include multiple video frames, and the multiple video frames may be arranged according to a sequential order of time information.

It is to be noted that the audio information has corresponding time information and, correspondingly, the video information has corresponding time information. Since the audio information and the video information are from the same audio and video file, it is determined/judged whether the audio information and the video information are synchronous or not, which can be understood that it is judged whether the audio information and video information with the same time information match or not.

In operation S12, feature fusion is performed on a spectrum feature of the audio information and a video feature of the video information based on time information of the audio information and time information of the video information to obtain at least one fused feature.

In the embodiment of the disclosure, feature extraction may be performed on the audio information to obtain the spectrum feature of the audio information, and time information of the spectrum feature is determined according to the time information of the audio information. Correspondingly, feature extraction may be performed on the video information to obtain the video feature of the video information, and time information of the video feature is determined according to the time information of the video information. Then, feature fusion may be performed on the spectrum feature and video feature with the same time information based on the time information of the spectrum feature and the time information of the video feature to obtain the at least one fused feature. Herein, feature fusion may be performed on the spectrum feature and video feature with the same time information, so it may be ensured that the spectrum feature and the video feature are aligned in time during feature fusion, so as to achieve relatively high accuracy of the obtained fused feature.

In operation S13, it is determined, based on the at least one fused feature, whether the audio information and the video information are synchronous.

In the embodiment of the disclosure, the fused feature may be processed by use of a neural network, or the fused feature may be processed in another manner. No limits are made herein. For example, convolution processing, full connection processing, a normalization operation and/or the like may be performed on the fused feature to obtain a judgment result of whether the audio information and the video information are synchronous or not. Herein, the judgment result may be a probability that the audio information and the video information are synchronous. If the judgment result is close to 1, it may be indicated that the audio information and the video information are synchronous, and if the judgment result is close to 0, it may be indicated that the audio information and the video information are asynchronous. Therefore, through the fused feature, the judgment result with relatively high accuracy is obtained, and the accuracy of judging whether the audio information and the video information are synchronous is improved. For example, the method for processing audio and video information provided in the embodiment of the disclosure may be adopted to discriminate a video of which a sound and an image are asynchronous, and may be applied to a scenario such as a video website to screen out some low-quality videos of which sounds and images are asynchronous.

In the embodiment of the disclosure, the audio information and the video information of the audio and video file may be acquired, feature fusion is performed on the spectrum feature of the audio information and the video feature of the video information based on the time information of the audio information and the time information of the video information to obtain the at least one fused feature, and it is determined, based on the at least one fused feature, whether the audio information and the video information are synchronous. In such a manner, when it is judged whether the audio information and video information of the audio and video file are synchronous or not, the spectrum feature and the video feature may be aligned by use of the time information of the audio information and the time information of the video information, so that the accuracy of the judgment result is improved, and this judgment manner is simple and easy to implement.

In the embodiment of the disclosure, the audio information may be a level signal, a frequency distribution of the audio information may be determined according to the level value and the time information of the audio information, a spectrogram corresponding to the audio information is determined according to the frequency distribution of the audio information, and the spectrum feature of the audio information is obtained according to the spectrogram.

FIG. 2 is a flowchart of a process for obtaining a spectrum feature of audio information according to an embodiment of the disclosure.

In a possible implementation mode, the aforementioned method for processing audio and video information may further include the following operations.

In operation S21, the audio information is segmented according to a first preset time stride to obtain at least one audio segment.

In operation S22, a frequency distribution of each audio segment is determined.

In operation S23, the frequency distribution of the at least one audio segment is concatenated to obtain a spectrogram corresponding to the audio information.

In operation S24, feature extraction is performed on the spectrogram to obtain the spectrum feature of the audio information.

In the implementation mode, the audio information may be segmented according to the first preset time stride to obtain multiple audio segments. Each audio segment corresponds to a respective first time stride, and the first time stride may be the same as a time interval for sampling of the audio information. For example, the audio information is segmented according to a time stride of 0.005 seconds to obtain n audio segments, here, n is a positive integer, and correspondingly, the video information may also be sampled to obtain n video frames. Then, the frequency distribution of each audio segment may be determined, namely a distribution of a frequency, changing with changing of the time information, of each audio segment is determined. The frequency distribution of each audio segment may be concatenated in a sequential order of the time information of each audio segment to obtain a frequency distribution corresponding to the audio information, and the obtained frequency distribution corresponding to the audio information may be graphically represented to obtain the spectrogram corresponding to the audio information. Herein, the spectrogram may represent a frequency distribution graph of the frequency, changing with the time information, of the audio information. For example, if the frequency distribution of the audio information is relatively dense, an image position corresponding to the spectrogram has a relatively high pixel value, and if the frequency distribution of the audio information is relatively sparse, the image position corresponding to the spectrogram has a relatively low pixel value. The frequency distribution of the audio information is visually represented through the spectrogram. Then, feature extraction is performed on the spectrogram by use of the neural network to obtain the spectrum feature of the audio information. The spectrum feature may be represented as a spectrum feature map. The spectrum feature map may include information of two dimensions, one dimension may be a feature dimension and represents a spectrum feature corresponding to each time point, and the other dimension may be a time dimension and represents the time point corresponding to the spectrum feature.

By representing the audio information as the spectrogram, the audio information and the video information are combined better, thereby reducing complicated operation processes of voice recognition for the audio information and the like, so that a process of judging whether the audio information and the video information are synchronous or not is simpler.

In an example of the implementation mode, windowing processing may be performed on each audio segment to obtain each windowed audio segment, and Fourier transform is performed on each windowed audio segment to obtain the frequency distribution of each of the at least one audio segment.

In the example, when the frequency distribution of each audio segment is determined, windowing processing may be performed on each audio segment, namely a window function may act on each audio segment. For example, windowing processing is performed on each audio segment by use of a hamming window to obtain each windowed audio segment. Then, Fourier transform may be performed on each windowed audio segment to obtain the frequency distribution of each audio segment. If a maximum frequency in frequency distributions of multiple audio segments is m, a size of the spectrogram obtained by concatenating the frequency distributions of the multiple audio segments may be m×n. By performing windowing processing and Fourier transform on each audio segment, the frequency distribution corresponding to each audio segment is accurately obtained.

In the embodiment of the disclosure, the acquired video information may be resampled to obtain multiple video frames. For example, the video information is resampled at a sampling rate of 100 frames per second. Time information of each video frame obtained by resampling is the same as the time information of a respective one of the audio segments. Then, image feature extraction is performed on the obtained video frames to obtain an image feature of each video frame; according to the image feature of each video frame, a target key point with a target image feature in the video frame is determined; an image region where the target key point is located is determined; and the image region is cropped to obtain a target image frame of the target key point.

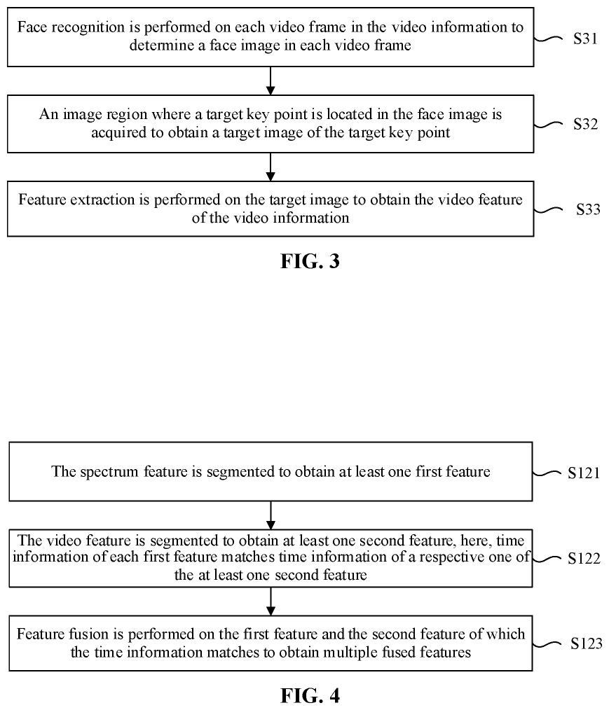

FIG. 3 is a flowchart of a process for obtaining a video feature of video information according to an embodiment of the disclosure.

In a possible implementation mode, the method for processing audio and video information may include the following operations.

In operation S31, face recognition is performed on each video frame in the video information to determine a face image in each video frame.

In operation S32, an image region where a target key point is located in the face image is acquired to obtain a target image of the target key point.

In operation S33, feature extraction is performed on the target image to obtain the video feature of the video information.

In the possible implementation mode, image feature extraction may be performed on each video frame of the video information. For any video frame, face recognition may be performed on the video frame according to the image feature of the video frame to determine the face image in each video frame. Then, for the face image, the target key point with the target image feature and the image region where the target key point is located are determined in the face image. Herein, the image region where the target key point is located may be determined by use of a set face template. For example, a position of the target key point in the face template may be taken as a reference. For example, if the target key point is at a ½ image position of the face template, it may be considered that the target key point is also at the ½ image position of the face image. After the image region where the target key point is located in the face image is determined, the image region where the target key point is located may be cropped to obtain the target image corresponding to the video frame. In such a manner, the target image of the target key point may be obtained by use of the face image, so that the obtained target image of the target key point is more accurate.

In an example, the image region where the target key point is located in the face image may be scaled to a preset image size to obtain the target image of the target key point. Herein, sizes of the image regions where the target key points are located in different face images may be different, so that the image regions of the target key points may be scaled to the preset image size in a unified manner, for example, scaled to the same image size as the video frame. In such a manner, image sizes of obtained multiple target images are kept consistent, so that video features extracted from the multiple target images also have the same feature map size.

In an example, the target key point may be a lip key point, and the target image may be a lip image. The lip key point may be a key point such as a lip center point, a mouth corner point, an upper lip edge point or a lower lip edge point. Referring to the face template, the lip key point may be in a lower ⅓ image region of the face image, so that the lower ⅓ image region of the face image may be cropped, and an image obtained by scaling the cropped lower ⅓ image region is determined as a lip image. The audio information of the audio and video file and a lip movement are correspondingly associated (a sound is produced under the assistance of the lip), so that the lip image may be used when it is determined whether the audio information and the video information are synchronous, thus the accuracy of the judgment result is improved.

Herein, the spectrogram may be an image, each video frame may correspond to a respective one of target image frames, and the target image frames may form a target image frame sequence. The spectrogram and the target image frame sequence may be taken as an input of the neural network, and the judgment result of whether the audio information and the video information are synchronous or not may be taken as an output of the neural network.

FIG. 4 is a flowchart of a process for obtaining fused feature(s) according to an embodiment of the disclosure.

In a possible implementation mode, operation S12 may include the following operations.

In operation S121, the spectrum feature is segmented to obtain at least one first feature.

In operation S122, the video feature is segmented to obtain at least one second feature, here, time information of each first feature matches time information of a respective one of the at least one second feature.

In operation S123, feature fusion is performed on the first feature and the second feature of which the time information matches, to obtain multiple fused features.

In the implementation mode, convolution processing may be performed on the spectrogram corresponding to the audio information by use of the neural network to obtain the spectrum feature of the audio information, and the spectrum feature may be represented by a spectrum feature map. The audio information has the time information, the spectrum feature of the audio information also has the time information, and a first dimension of the corresponding spectrum feature map may be the time dimension. Then, the spectrum feature is segmented to obtain multiple first features. For example, the spectrum feature is segmented into multiple first features according to a time stride of 1 s. Correspondingly, convolution processing may be performed on the multiple target image frames by use of the neural network to obtain the video feature. The video feature may be represented by a video feature map, and a first dimension of the video feature map is the time dimension. Then, the video feature is segmented to obtain multiple second features. For example, the video feature is segmented into multiple second features according to a time stride of 1 s. Herein, the time stride for segmenting the video feature is the same as the time stride for segmenting the audio feature. Time information of the first features is in one-to-one correspondences with time information of the second features. That is, if there are three first features and three second features, time information of the first feature 1 is the same as time information of the second feature 1, time information of the first feature 2 is the same as time information of the second feature 2, and time information of the first feature 3 is the same as time information of the second feature 3. Then, feature fusion may be performed on the first features and second features of which the time information matches by use of the neural network to obtain multiple fused features. By segmenting the spectrum feature and the video feature, feature fusion may be performed on the first features and second features with the same time information to obtain the fused features with different time information.

In an example, the spectrum feature may be segmented according to a second preset time stride to obtain the at least one first feature; or, the spectrum feature is segmented according to the number of target image frames to obtain the at least one first feature. In the example, the spectrum feature may be segmented into multiple first features according to the second preset time stride. The second preset time stride may be set according to a practical application scenario. For example, the second preset time stride is set to be 1 s, 0.5 s or the like, so that the spectrum feature may be segmented according to any time stride. Or, the spectrum feature may be segmented into first features of which the number is the same as the number of the target image frames, the time stride of each first feature is the same. In such a manner, the spectrum feature is segmented into a certain number of first features.

In an example, the video feature may be segmented according to the second preset time stride to obtain the at least one second feature; or, the video feature is segmented according to the number of the target image frames to obtain the at least one second feature. In the example, the video feature may be segmented into multiple second features according to the second preset time stride. The second preset time stride may be set according to the practical application scenario, for example, set to be 1 s, 0.5 s, so that the video feature may be segmented according to any time stride. Or, the video feature may be segmented into second features of which the number is the same as the number of the target image frames, the time stride of each second feature is the same. In such a manner, the video feature is segmented into a certain number of second features.

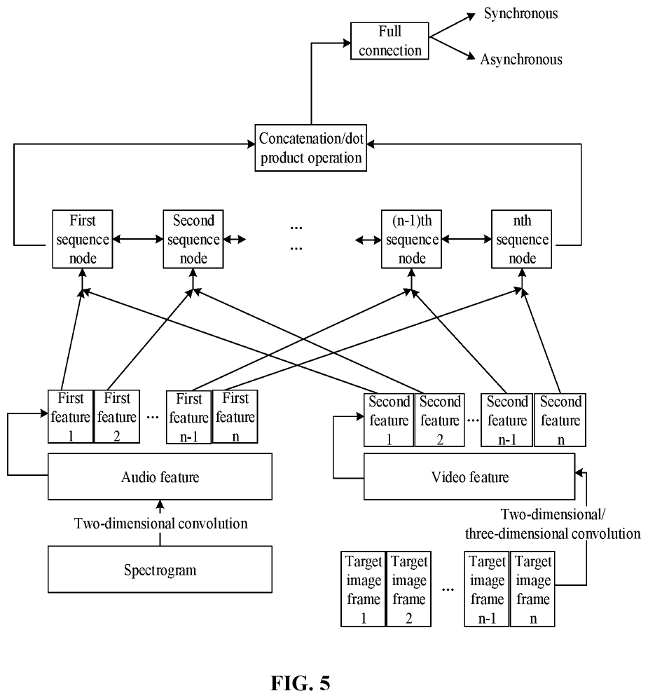

FIG. 5 is a block diagram of an example of a neural network according to an embodiment of the disclosure. The implementation mode will be described below in combination with FIG. 5.

Herein, two-dimensional convolution processing may be performed on the spectrogram of the audio information by use of the neural network to obtain a spectrum feature map. A first dimension of the spectrum feature map may be the time dimension and represent the time information of the audio information. Therefore, the spectrum feature map may be segmented according to the time information of the spectrum feature map and according to the preset time stride to obtain multiple first features. For each first feature, there is a second feature matching the first feature. That is, it can be understood that for any first feature, there is a second feature of which the time information matches the time information of the first feature, and there is also a target image frame of which the time information matches the time information of the first feature. The first feature includes an audio feature, with corresponding time information, of the audio information.

Correspondingly, two-dimensional or three-dimensional convolution processing may be performed on the target image frame sequence formed by the target image frames by use of the neural network to obtain the video feature. The video feature may be represented as a video feature map, and a first dimension of the video feature map is the time dimension and represents the time information of the video information. Then, the video feature may be segmented according to the time information of the video feature and according to the preset time stride to obtain multiple second features. For each second feature, there is a first feature of which the time information matches the time information of the second feature, and each second feature includes a video feature, with corresponding time information, of the video information.

Then, feature fusion may be performed on the first features and second features with the same time information to obtain the multiple fused features. Different fused features correspond to different time information, and each fused feature may include an audio feature from the first feature and a video feature from the second feature. If there are n first features and n second features respectively, the n first features and the n second features are respectively numbered in a sequential order of time information of the first features and the second features. The n first features may be represented as a first feature 1, a first feature 2, . . . and a first feature n; and the n second features may be represented as a second feature 1, a second feature 2, and a second feature n. When feature fusion is performed on the first features and the second features, the first feature 1 and the second feature 1 may be fused to obtain a fused feature 1, the first feature 2 and the second feature 2 may be fused to obtain a fused feature 2, . . . , and the first feature n and the second feature n may be fused to obtain a fused feature n.

In a possible implementation mode, feature extraction may be performed on each fused feature by use of different sequence nodes in a sequential order of time information of each fused feature, then processing results output by starting and ending sequence nodes are acquired, and it is judged according to the processing results whether the audio information and the video information are synchronous or not. Herein, a next sequence node takes a processing result of a previous sequence node as an input.

In the implementation mode, the neural network may include multiple sequence nodes, each sequence node is sequentially connected, and feature extraction is performed on the fused features with different time information by use of the multiple sequence nodes respectively. As illustrated in FIG. 5, if there are n fused features, the n fused features, which are numbered in the sequential order of the time information, may be represented as the fused feature 1, the fused feature 2, . . . and the fused feature n. When feature extraction is performed on the fused features by use of the sequence nodes, feature extraction may be performed on the fused feature 1 by use of a first sequence node to obtain a first processing result, feature extraction may be performed on the fused feature 2 by use of a second sequence node to obtain a second processing result, . . . and feature extraction may be performed on the fused feature n by use of an nth sequence node to obtain an nth processing result. Moreover, the second processing result is received by use of the first sequence node, and the first processing result and the third processing result are received by use of the second sequence node, and so on. Then, the processing result of the first sequence node and the processing result of the last sequence node may be fused, for example, a concatenation or dot product operation is performed, to obtain a fused processing result. Then, feature extraction, for example, full connection processing and/or the normalization operation, may be further performed on the fused processing result by use of a fully connected layer of the neural network to obtain the judgment result of whether the audio information and the video information are synchronous or not.

In a possible implementation mode, the spectrogram corresponding to the audio information may be segmented according to the number of the target image frames to obtain at least one spectrogram segment, here, time information of each spectrogram segment matches the time information of a respective one of the target image frames. Then, feature extraction is performed on each spectrogram segment to obtain each first feature, and feature extraction is performed on each target image frame to obtain each second feature. Feature fusion is performed on the first feature and second feature of which the time information matches to obtain the multiple fused features.

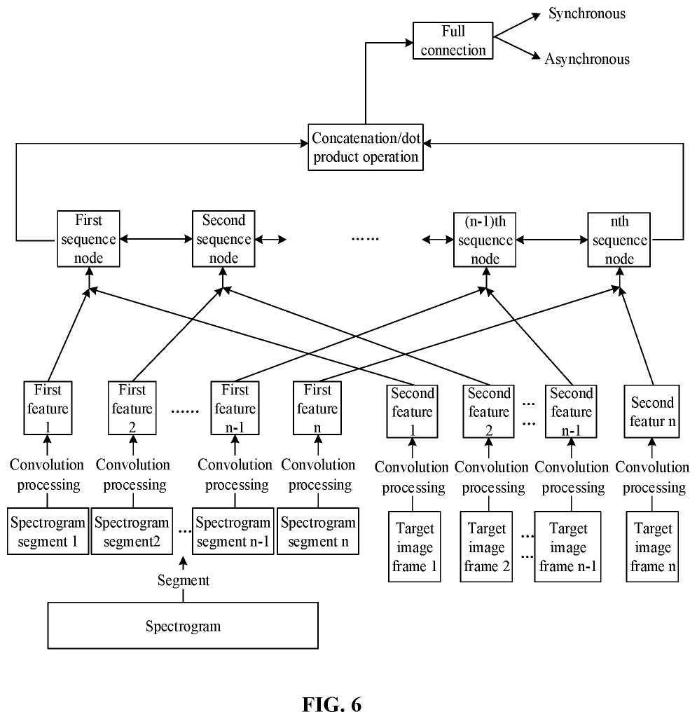

FIG. 6 is a block diagram of an example of a neural network according to an embodiment of the disclosure. A fusion manner provided in the abovementioned implementation mode will be described below in combination with FIG. 6.

In the implementation mode, the spectrogram corresponding to the audio information may be segmented according to the number of the target image frames to obtain the at least one spectrogram segment, and then feature extraction is performed on the at least one spectrogram segment to obtain the at least one first feature. Herein, the number of the spectrogram segments, which is obtained by segmenting the spectrogram corresponding to the audio information according to the number of the target image frames, is the same as the number of the target image frames, so that it may be ensured that the time information of each spectrogram segment matches the time information of a respective target image frame. If n spectrogram segments are obtained and numbered in the sequential order of the time information, the multiple spectrogram segments may be represented as a spectrogram segment 1, a spectrogram segment 2, . . . and a spectrogram segment n. For each spectrogram segment, two-dimensional convolution processing may be performed on the n spectrogram segments by use of the neural network to finally obtain the n first features.

Correspondingly, when convolution processing is performed on the target image frames to obtain the second features, convolution processing may be performed on the multiple target image frames by use of the neural network respectively, to obtain the multiple second features. If there are n target image frames and the n target image frames are numbered in the sequential order of the time information, the n target image frames may be represented as a target image frame 1, a target image frame 2, . . . and a target image frame n. For each target image frame, two-dimensional convolution processing may be performed on each target image frame by use of the neural network to finally obtain the n second features.

Then, feature fusion may be performed on the first features and second features of which the time information matches, and it is judged, according to a fused feature map obtained by the feature fusion, whether the audio information and the video information are synchronous or not. Herein, the process of judging, according to the fused feature map, whether the audio information and the video information are synchronous or not is the same as the process in the implementation mode corresponding to FIG. 5 and will not be elaborated herein. In the example, by performing feature extraction on the multiple spectrogram segments and the multiple target image frames respectively, computations for convolution processing are reduced, and the audio and video information processing efficiency is improved.

In a possible implementation mode, feature extraction of at least one level may be performed on the fused feature in the time dimension to obtain a processing result obtained through the feature extraction of the at least one level, here, feature extraction of each level includes convolution processing and full connection processing. Then, it is judged, based on the processing result obtained through the feature extraction of the at least one level, whether the audio information and the video information are synchronous or not.

In the possible implementation mode, multi-level feature extraction may be performed on the fused feature map by the neural network in the time dimension, and feature extraction of each level may include convolution processing and full connection processing. Herein, the time dimension may be the first feature of the fused feature, and a processing result after the multi-level feature extraction may be obtained by the multi-level feature extraction. Then, the concatenation or dot product operation, a full connection operation, the normalization operation and/or the like may further be performed on the processing result obtained through the multi-level feature extraction to obtain the judgment result of whether the audio information and the video information are synchronous or not.

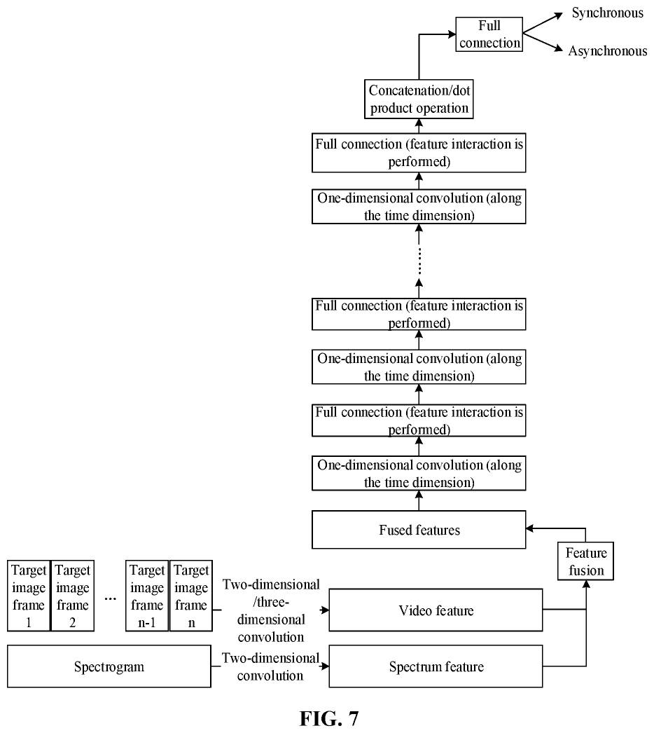

FIG. 7 is a block diagram of an example of a neural network according to an embodiment of the disclosure. In the abovementioned implementation mode, the neural network may include multiple one-dimensional convolutional layers and the fully connected layers. The two-dimensional convolution processing may be performed on the spectrogram by use of the neural network illustrated in FIG. 7 to obtain the spectrum feature of the audio information, and the first dimension of the spectrum feature may be the time dimension and may represent the time information of the audio information. Correspondingly, two-dimensional or three-dimensional convolution processing may be performed on the target image frame sequence formed by the target image frames by use of the neural network to obtain the video feature of the video information, and the first dimension of the video feature is the time dimension and may represent the time information of the video information. Then, the audio feature and the video feature may be fused by use of the neural network according to the time information corresponding to the audio feature and the time information corresponding to the video feature, for example, the audio feature and video feature with the same time information are concatenated, to obtain the fused feature. The first dimension of the fused feature represents the time information, and the fused feature with certain time information may correspond to the audio feature with the time information and the video feature with the time information. Then, feature extraction of at least one level may be performed on the fused feature in the time dimension, for example, one-dimensional convolution processing and full connection processing are performed on the fused feature, to obtain the processing result. Then, the concatenation or dot product operation, the full connection operation, the normalization operation and/or the like may further be performed on the processing result to obtain the judgment result of whether the audio information and the video information are synchronous or not.

Through the audio and video information processing solution provided in the embodiment of the disclosure, the spectrogram corresponding to the audio information may be combined with the target image frame of the target key point to judge whether the audio information and video information of the audio and video file are synchronous or not, the judgment manner is simple, and the judgment result is high in accuracy.

The audio and video information processing solution provided in the embodiment of the disclosure may be applied to a living body discrimination task to judge whether audio information and video information of an audio and video file in the living body discrimination task are synchronous or not, thereby screening out some suspicious attacking audio and video files in the living body discrimination task. In some implementation modes, the judgment result in the audio and video information processing solution provided in the disclosure may also be adopted to judge an offset of the audio information and video information of the same audio and video file, thereby further determining the time difference of audio information and video information of an asynchronous audio and video file.

It can be understood that each method embodiment mentioned in the disclosure may be combined to form combined embodiments without departing from principles and logics. For saving the space, elaborations are omitted in the disclosure.

In addition, the disclosure also provides a device for processing audio and video information, an electronic device, a computer-readable storage medium and a program. All of them may be configured to implement any method for processing audio and video information provided in the disclosure. Corresponding technical solutions and descriptions may refer to the corresponding records in the method embodiments and will not be elaborated.

It can be understood by those skilled in the art that in the method of the specific implementation modes, the writing sequence of each operation does not mean a strict execution sequence and is not intended to form any limit to the implementation process and a specific execution sequence of each operation should be determined by functions and probable internal logic thereof.

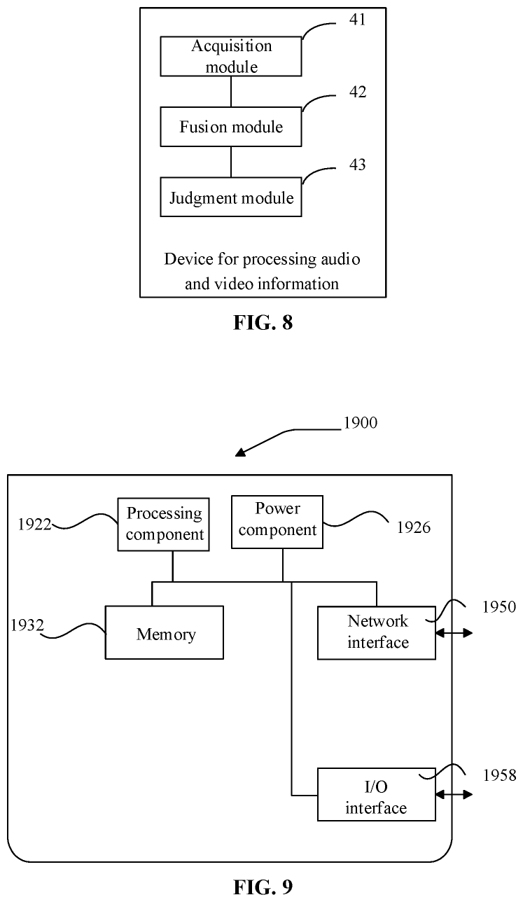

FIG. 8 is a block diagram of a device for processing audio and video information according to an embodiment of the disclosure. As illustrated in FIG. 8, the device for processing audio and video information includes an acquisition module 41, a fusion module 42 and a judgment module 43.

The acquisition module 41 is configured to acquire audio information and video information of an audio and video file.

The fusion module 42 is configured to perform feature fusion on a spectrum feature of the audio information and a video feature of the video information based on time information of the audio information and time information of the video information to obtain at least one fused feature.

The judgment module 43 is configured to determine, based on the at least one fused feature, whether the audio information and the video information are synchronous.

In a possible implementation mode, the device further includes a first determination module.

The first determination module is configured to segment the audio information according to a preset time stride to obtain at least one audio segment, determine a frequency distribution of each audio segment, concatenate the frequency distribution of the at least one audio segment to obtain a spectrogram corresponding to the audio information and perform feature extraction on the spectrogram to obtain the spectrum feature of the audio information.

In a possible implementation mode, the first determination module is specifically configured to: segment the audio information according to a first preset time stride to obtain at least one initial segment; perform windowing processing on each initial segment to obtain each windowed initial segment; and perform Fourier transform on each windowed initial segment to obtain each audio segment in the at least one audio segment.

In a possible implementation mode, the device further includes a second determination module.

The second determination module is configured to perform face recognition on each video frame in the video information to determine a face image in each video frame, acquire an image region where a target key point is located in the face image to obtain a target image of the target key point and perform feature extraction on the target image to obtain the video feature of the video information.

In a possible implementation mode, the second determination module is specifically configured to scale the image region where the target key point is located in the face image to a preset image size to obtain the target image of the target key point.

In a possible implementation mode, the target key point is a lip key point, and the target image is a lip image.

In a possible implementation mode, the fusion module 42 is specifically configured to: segment the spectrum feature to obtain at least one first feature; segment the video feature to obtain at least one second feature, here, time information of each first feature matches time information of a respective one of the at least one second feature; and perform feature fusion on the first feature and the second feature of which the time information matches to obtain multiple fused features.

In a possible implementation mode, the fusion module 42 is specifically configured to: segment the spectrum feature according to a second preset time stride to obtain the at least one first feature; or, segment the spectrum feature according to the number of target image frames to obtain the at least one first feature.

In a possible implementation mode, the fusion module 42 is specifically configured to: segment the audio feature according to the second preset time stride to obtain the at least one second feature; or, segment the video feature according to the number of the target image frames to obtain the at least one second feature.

In a possible implementation mode, the fusion module 42 is specifically configured to: segment the spectrogram corresponding to the audio information according to the number of the target image frames to obtain at least one spectrogram segment, here, time information of each spectrogram segment matches time information of a respective one of the target image frames; perform feature extraction on each spectrogram segment to obtain each first feature; perform feature extraction on each target image frame to obtain each second feature; and perform feature fusion on the first feature and the second feature of which the time information matches to obtain multiple fused features.

In a possible implementation mode, the judgment module 43 is specifically configured to: perform feature extraction on each fused feature by use of different sequence nodes in a sequential order of time information of each fused feature, here, a next sequence node takes a processing result of a previous sequence node as an input; and acquire processing results output by starting and ending sequence nodes and determine, according to the processing results, whether the audio information and the video information are synchronous.

In a possible implementation mode, the judgment module 43 is specifically configured to: perform feature extraction of at least one level on the fused feature in a time dimension to obtain a processing result obtained through the feature extraction of the at least one level, here, feature extraction of each level includes convolution processing and full connection processing; and determine, based on the processing result obtained through the feature extraction of the at least one level, whether the audio information and the video information are synchronous.

In some embodiments, functions or modules of the device provided in the embodiment of the disclosure may be configured to execute the method described in the above method embodiment and specific implementation thereof may refer to the descriptions about the method embodiment and, for simplicity, will not be elaborated herein.

The embodiments of the disclosure also disclose a computer-readable storage medium, which has stored thereon a computer program instruction that, when executed by a processor, causes the processor to implement the aforementioned method. The computer-readable storage medium may be a volatile computer-readable storage medium or a nonvolatile computer-readable storage medium.

The embodiments of the disclosure also disclose a computer program is provided, which includes a computer-readable code that, when being run in an electronic device, causes a processor in the electronic device to execute the aforementioned method for processing audio and video information.

The embodiments of the disclosure disclose an electronic device, which includes a processor and a memory configured to store an instruction executable by the processor, here, the processor is configured to perform the aforementioned method.

The electronic device may be provided as a terminal, a server or a device in another form.

FIG. 9 is a block diagram of an electronic device 1900 according to an exemplary embodiment. For example, the electronic device 1900 may be provided as a server. Referring to FIG. 9, the electronic device 1900 includes a processing component 1922, further including one or more processors, and a memory resource represented by a memory 1932, configured to store an instruction executable by the processing component 1922, for example, an application program. The application program stored in the memory 1932 may include one or more than one module of which each corresponds to a set of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to connect the electronic device 1900 to a network and an Input/Output (I/O) interface 1958. The electronic device 1900 may be operated based on an operating system stored in the memory 1932, for example, Windows Server™, Mac OS X™, Unix™, Linux™, FreeBSD™ or the like.

In the exemplary embodiment, a nonvolatile computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium which has a computer-readable program instruction configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a Read-Only Memory (ROM), an Erasable Programmable ROM (EPROM) (or a flash memory), a Static RAM (SRAM), a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be connected to the computer of the user through any type of network including an LAN or a WAN, or, may be connected to an external computer (for example, connected by an Internet service provider through the Internet). In some embodiments, an electronic circuit such as a programmable logic circuit, a Field-Programmable Gate Array (FPGA) or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

What is claimed is:

1. A method for processing audio and video information, comprising:
acquiring audio information and video information of an audio and video file;
performing feature fusion on a spectrum feature of the audio information and a video feature of the video information based on time information of the audio information and time information of the video information to obtain at least one fused feature; and
determining, based on the at least one fused feature, whether the audio information and the video information are synchronous.

2. The method of claim 1, further comprising:
segmenting the audio information according to a first preset time stride to obtain at least one audio segment;
determining a frequency distribution of each audio segment;
concatenating the frequency distribution of the at least one audio segment to obtain a spectrogram corresponding to the audio information; and
performing feature extraction on the spectrogram to obtain the spectrum feature of the audio information.

3. The method of claim 2, wherein determining the frequency distribution of each audio segment comprises:
performing windowing processing on each audio segment to obtain each windowed audio segment; and
performing Fourier transform on each windowed audio segment to obtain the frequency distribution of each of the at least one audio segment.

4. The method of claim 1, further comprising:
performing face recognition on each video frame in the video information to determine a face image in each video frame;
acquiring an image region where a target key point is located in the face image to obtain a target image of the target key point; and
performing feature extraction on the target image to obtain the video feature of the video information.

5. The method of claim 4, wherein acquiring the image region where the target key point is located in the face image to obtain the target image of the target key point comprises:
scaling the image region where the target key point is located in the face image to a preset image size to obtain the target image of the target key point.

6. The method of claim 4, wherein the target key point is a lip key point, and the target image is a lip image.

7. The method of claim 1, wherein performing feature fusion on the spectrum feature of the audio information and the video feature of the video information based on the time information of the audio information and the time information of the video information to obtain the at least one fused feature comprises:
segmenting the spectrum feature to obtain at least one first feature;
segmenting the video feature to obtain at least one second feature, wherein time information of each first feature matches time information of a respective one of the at least one second feature; and
performing feature fusion on the first feature and the second feature of which the time information matches to obtain a plurality of fused features.

8. The method of claim 7, wherein segmenting the spectrum feature to obtain the at least one first feature comprises:
segmenting the spectrum feature according to a second preset time stride to obtain the at least one first feature; or,
segmenting the spectrum feature according to a number of target image frames to obtain the at least one first feature.

9. The method of claim 8, wherein segmenting the video feature to obtain the at least one second feature comprises:
segmenting the video feature according to the second preset time stride to obtain the at least one second feature; or,
segmenting the video feature according to the number of the target image frames to obtain the at least one second feature.

10. The method of claim 1, wherein performing feature fusion on the spectrum feature of the audio information and the video feature of the video information based on the time information of the audio information and the time information of the video information to obtain the at least one fused feature comprises:
segmenting a spectrogram corresponding to the audio information according to a number of target image frames to obtain at least one spectrogram segment, wherein time information of each spectrogram segment matches time information of a respective one of the target image frames;
performing feature extraction on each spectrogram segment to obtain each first feature;
performing feature extraction on each target image frame to obtain each second feature; and
performing feature fusion on the first feature and the second feature of which the time information matches to obtain a plurality of fused features.

11. The method of claim 1, wherein determining, based on the at least one fused feature, whether the audio information and the video information are synchronous comprises:
performing feature extraction on each fused feature by use of different sequence nodes in a sequential order of time information of each fused feature, wherein a next sequence node takes a processing result of a previous sequence node as an input; and
acquiring processing results output by starting and ending sequence nodes, and determining, according to the processing results, whether the audio information and the video information are synchronous.

12. The method of claim 1, wherein determining, based on the at least one fused feature, whether the audio information and the video information are synchronous comprises:
performing feature extraction of at least one level on the fused feature in a time dimension to obtain a processing result obtained through the feature extraction of the at least one level, wherein feature extraction of each level comprises convolution processing and full connection processing; and
determining, based on the processing result obtained through the feature extraction of the at least one level, whether the audio information and the video information are synchronous.

13. An electronic device, comprising:
a processor; and
a memory, configured to store an instruction executable by the processor,
wherein the processor is configured to:
acquire audio information and video information of an audio and video file;
perform feature fusion on a spectrum feature of the audio information and a video feature of the video information based on time information of the audio information and time information of the video information to obtain at least one fused feature; and
determine, based on the at least one fused feature, whether the audio information and the video information are synchronous.

14. The electronic device of claim 13, wherein the processor is further configured to:
segment the audio information according to a preset time stride to obtain at least one audio segment, determine a frequency distribution of each audio segment, concatenate the frequency distribution of the at least one audio segment to obtain a spectrogram corresponding to the audio information and perform feature extraction on the spectrogram to obtain the spectrum feature of the audio information.

15. The electronic device of claim 13, wherein the processor is further configured to:
perform face recognition on each video frame in the video information to determine a face image in each video frame, acquire an image region where a target key point is located in the face image to obtain a target image of the target key point and perform feature extraction on the target image to obtain the video feature of the video information; and
the processor is further configured to:
scale the image region where the target key point is located in the face image to a preset image size to obtain the target image of the target key point.

16. The electronic device of claim 13, wherein the processor is further configured to:
segment the spectrum feature to obtain at least one first feature;
segment the video feature to obtain at least one second feature, wherein time information of each first feature matches time information of a respective one of the at least one second feature; and
perform feature fusion on the first feature and the second feature of which the time information matches to obtain a plurality of fused features.

17. The electronic device of claim 16, wherein the processor is further configured to:
segment the spectrum feature according to a second preset time stride to obtain the at least one first feature; or,
segment the spectrum feature according to a number of target image frames to obtain the at least one first feature; and
the processor is further configured to:
segment the video feature according to the second preset time stride to obtain the at least one second feature; or,
segment the video feature according to the number of the target image frames to obtain the at least one second feature.

18. The electronic device of claim 13, wherein the processor is further configured to:
segment a spectrogram corresponding to the audio information according to a number of target image frames to obtain at least one spectrogram segment, wherein time information of each spectrogram segment matches time information of a respective one of the target image frames;
perform feature extraction on each spectrogram segment to obtain each first feature;
perform feature extraction on each target image frame to obtain each second feature; and
perform feature fusion on the first feature and the second feature of which the time information matches to obtain a plurality of fused features.

19. The electronic device of claim 13, wherein the processor is further configured to:
perform feature extraction on each fused feature by use of different sequence nodes in a sequential order of time information of each fused feature, wherein a next sequence node takes a processing result of a previous sequence node as an input; and
acquire processing results output by starting and ending sequence nodes and determine, according to the processing results, whether the audio information and the video information are synchronous,
or,
wherein the processor is further configured to:
perform feature extraction of at least one level on the fused feature in a time dimension to obtain a processing result obtained through the feature extraction of the at least one level, wherein feature extraction of each level comprises convolution processing and full connection processing; and
determine, based on the processing result obtained through the feature extraction of the at least one level, whether the audio information and the video information are synchronous.

20. A non-transitory computer-readable storage medium, having stored thereon a computer program instruction that, when executed by a processor, causes the processor to:
acquire audio information and video information of an audio and video file;
perform feature fusion on a spectrum feature of the audio information and a video feature of the video information based on time information of the audio information and time information of the video information to obtain at least one fused feature; and
determine, based on the at least one fused feature, whether the audio information and the video information are synchronous.
